(19) United States
(12) Patent Application Publication
(10) Pub. No.: US 2026/0341191 A1
(43) Pub. Date: Oct. 29, 2026

(54) DISPLAY DEVICE, ELECTRONIC DEVICE INCLUDING DISPLAY DEVICE, AND METHOD FOR DRIVING DISPLAY DEVICE

(71) Applicant: Samsung Display Co., Ltd., Yongin-si (KR)

(72) Inventors: Juki PARK, Yongin-si (KR); Seong Min KIM, Yongin-si (KR); Sung-Jae PARK, Yongin-si (KR); Kyung-Uk CHOI, Yongin-si (KR)

(73) Assignee: Samsung Display Co., Ltd., Yongin-si (KR)

(21) Appl. No.: 19/575,055

(22) Filed: Mar. 23, 2026

(30) Foreign Application Priority Data
Apr. 24, 2025 (KR) 10-2025-0053892

(51) Int. Cl. G09G 3/20

(52) U.S. Cl. CPC G09G 3/2092; G09G 2320/0233; G09G 2330/10

(57) ABSTRACT

Provided is a display device which includes a display panel including a plurality of pixels; and a driver configured to generate image data based on an image signal and output the image data to the display panel, wherein the display panel includes a first area and a second area adjacent to the first area, the first area including a defective pixel among the plurality of pixels, wherein the plurality of pixels include at least one first compensation pixel in the first area and at least one normal pixel in the second area, and wherein the driver is configured to generate the image data such that a luminance level of the at least one first compensation pixel is lower than a luminance level of the at least one normal pixel.

### CROSS-REFERENCE TO RELATED APPLICATION

This application is based on and claims priority under 35 U.S.C. § 119 to Korean Patent Application No. 10-2025-0053892 filed on Apr. 24, 2025, in the Korean Intellectual Property Office, the disclosure of which is herein incorporated by reference in its entirety.

### BACKGROUND

Embodiments of the disclosure relate to a display device having improved image quality, an electronic device including the display device, and a method for driving the display device.

A multimedia electronic device such as a television (TV), a mobile phone, a tablet computer, a navigation system, or a game console includes a display device for displaying an image. The display device includes a plurality of pixels. The plurality of pixels may be formed by using the same process, however, due to a process deviation, some of the plurality of pixels may have different characteristics. Also, some of the plurality of pixels may be defective in a manufacturing process.

### SUMMARY

Embodiments of the disclosure provide a display device having improved image quality and an electronic device including the display device.

Embodiments of the disclosure provide a method for driving a display device to improve quality of image.

According to an aspect of an example embodiment of the disclosure, provided is a display device comprising: a display panel comprising a plurality of pixels; and a driver configured to generate image data based on an image signal and output the image data to the display panel, wherein the display panel comprises a first area and a second area adjacent to the first area, the first area comprising a defective pixel among the plurality of pixels, wherein the plurality of pixels comprise at least one first compensation pixel in the first area and at least one normal pixel in the second area, and wherein the driver is configured to generate the image data such that a luminance level of the at least one first compensation pixel is lower than a luminance level of the at least one normal pixel.

According to an aspect of an example embodiment of the disclosure, provided is a method of driving a display device, the method comprising: driving a display panel comprising a plurality of pixels, the display panel comprising a first area and a second area adjacent to the first area, the first area comprising a defective pixel among the plurality of pixels, wherein the driving the display panel comprises: generating first image data such that a luminance level of at least one first compensation pixel in the first area decreases; generating second image data such that a luminance level of at least one second compensation pixel in the first area increases; and outputting, to the display panel, image data comprising the first image data and the second image data.

According to an aspect of an example embodiment of the disclosure, provided is an electronic device comprising: a display panel comprising a plurality of pixels, the display panel comprising a first area and a second area adjacent to the first area, the first area comprising a defective pixel among the plurality of pixels; a processor configured to output an image signal; and a driver configured to output image data corresponding to the image signal to the display panel, wherein the plurality of pixels comprise at least one first compensation pixel and at least one second compensation pixel, which are in the first area, and at least one normal pixel in the second area, and wherein, based on the image signal including the same grayscale information for the at least one first compensation pixel, the at least one second compensation pixel, and the at least one normal pixel, a luminance level of the at least one normal pixel is higher than a luminance level of the at least one first compensation pixel, and the luminance level of the at least one normal pixel is lower than luminance level of the at least one second compensation pixel.

### BRIEF DESCRIPTION OF DRAWINGS

The above and other objects and features of the disclosure will become apparent by describing in detail certain embodiments thereof with reference to the accompanying drawings.

FIG. 1 is a block diagram of an electronic device according to one or more embodiments of the disclosure.

FIG. 2 illustrates a schematic view of electronic devices according to various embodiments.

FIG. 3 is a block diagram of a display device according to one or more embodiments of the disclosure.

FIG. 4 is a plan view of a display panel according to one or more embodiments of the disclosure.

FIG. 5 is a plan view of a display panel according to one or more embodiments of the disclosure.

FIG. 6 is a graph illustrating an example of luminance and perceptual luminance according to a location of a pixel of a display panel including a defective pixel.

FIG. 7 is a flowchart illustrating an operation of a driver according to one or more embodiments of the disclosure.

FIG. 8 is a plan view of a display panel according to one or more embodiments of the disclosure.

FIG. 9 is a plan view of a display panel according to one or more embodiments of the disclosure.

FIG. 10 is a graph illustrating an example of luminance and perceptual luminance according to a location of a pixel of a display panel including a defective pixel according to one or more embodiments of the disclosure.

FIG. 11 is a plan view of a display panel according to one or more embodiments of the disclosure.

### DETAILED DESCRIPTION

The disclosure will now be described more fully hereinafter with reference to the accompanying drawings, in which example embodiments of the disclosure are shown. The disclosure may, however, be embodied in different forms and should not be construed as limited to the embodiments set forth herein. Rather, these embodiments are provided such that this disclosure will be thorough and complete, and will filly convey the scope of the disclosure to those skilled in the art. In addition, one of ordinary skill would understand that aspects of some embodiments may be combined together or implemented alone.

In the specification, the expression that a first component (or area, layer, part, etc.) is “on”, “disposed on,” “connected to”, or “coupled to” a second component means that the first component is directly on, disposed on, connected to, or coupled to the second component or means that a third component is interposed therebetween.

The same reference numerals/signs refer to the same components. In addition, in drawings, thicknesses, proportions, and dimensions of components may be exaggerated to describe the technical features effectively. The term “and/or” includes all of one or more combinations of associated components.

Although the terms “first”, “second”, etc. may be used to describe various components, the components should not be construed as being limited by the terms. The terms are used only for the purpose of distinguishing one component, part, area, layer, or portion from another component, part, area, layer, or portion. For example, without departing from the scope of the disclosure, a first component, a first part, a first area, a first layer, or a first portion may be named a second component, a second part, a second area, a second layer, or a second portion, and similarly, the second component, the second part, the second area, the second layer, or the second portion may be named the first component, the first part, the first area, the first layer, or the first portion. The articles “a”, “an”, and “the” are singular in that they have a single referent, but the use of the singular form should not preclude the presence of more than one referent.

Each of the features of the various embodiments of the disclosure may be combined or combined with each other, in part or in whole, and technically various interlocking and driving are possible. Each embodiment may be implemented independently of each other or may be implemented together in an association.

The term “and/or” includes all combinations of one or more components that may be defined by associated components. As used herein, expressions such as “at least one of,” when preceding a list of elements, modify the entire list of elements and do not modify the individual elements of the list. For example, the expression, "at least one of a, b, and c," should be understood as including only a, only b, only c, both a and b, both a and c, both b and c, or all of a, b, and c.

Also, the terms “under”, “below”, “on”, “above”, etc. are used to describe the correlation of components illustrated in drawings. The terms are relative and are described with reference to a direction indicated in the drawing.

It will be further understood that the terms “comprises”, “includes”, “have”, etc. specify the presence of stated features, numbers, steps, operations, elements, components, or a combination thereof but do not preclude the presence or addition of one or more other features, numbers, steps, operations, elements, components, or a combination thereof.

Unless otherwise defined, all terms (including technical terms and scientific terms) used in the specification have the same meaning as commonly understood by one skilled in the art to which the disclosure belongs. In addition, the terms such as terms defined in the dictionaries commonly used should be interpreted as having a meaning consistent with the meaning in the context of the related technology, and should not be interpreted in ideal or overly formal meanings unless explicitly defined herein.

Hereinafter, example embodiments of the disclosure will be described with reference to accompanying drawings.

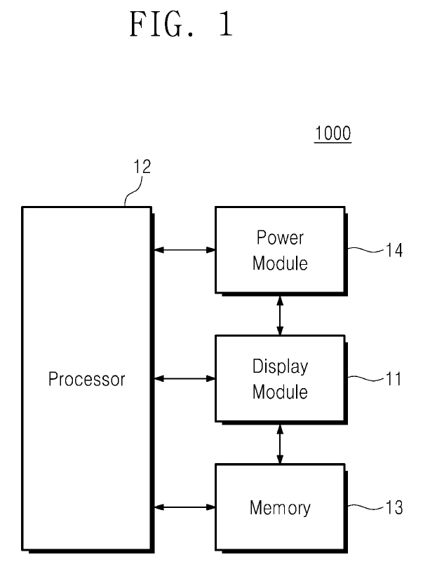

FIG. 1 is a block diagram of an electronic device 1000 according to one or more embodiments of the disclosure.

Referring to FIG. 1, the electronic device 1000 according to an embodiment may include a display module (or display device) 11, a processor 12, a memory 13, and a power module (or power circuitry) 14.

The display module 11 may display an image. The image may include a still image as well as a video (or a moving image). The display module 11 may include, for example but not limited to, organic light emitting diodes, quantum-dot organic light emitting diodes, micro-light-emitting diodes, nano-light-emitting diodes, liquid crystals, and/or the like. The processor 12 may include, for example but not limited to, at least one of a central processing unit (CPU), an application processor (AP), a graphic processing unit (GPU), a communication processor (CP), an image signal processor (ISP), and a controller. The processor 12 may be configured to control an operation of the display module 11. The processor 12 may include one or more processors.

Data information related to operations of the processor 12 or the display module 11 may be stored in the memory 13. When the processor 12 executes an application stored in the memory 13, an image data signal and/or an input control signal may be transferred to the display module 11, and the display module 11 may process the provided signal and may output image information through a display screen.

The power module 14 may include a power supply module such as a power adapter or a battery device and a power conversion module which converts the power supplied by the power supply module to operating voltages to be used in operating the electronic device 1000.

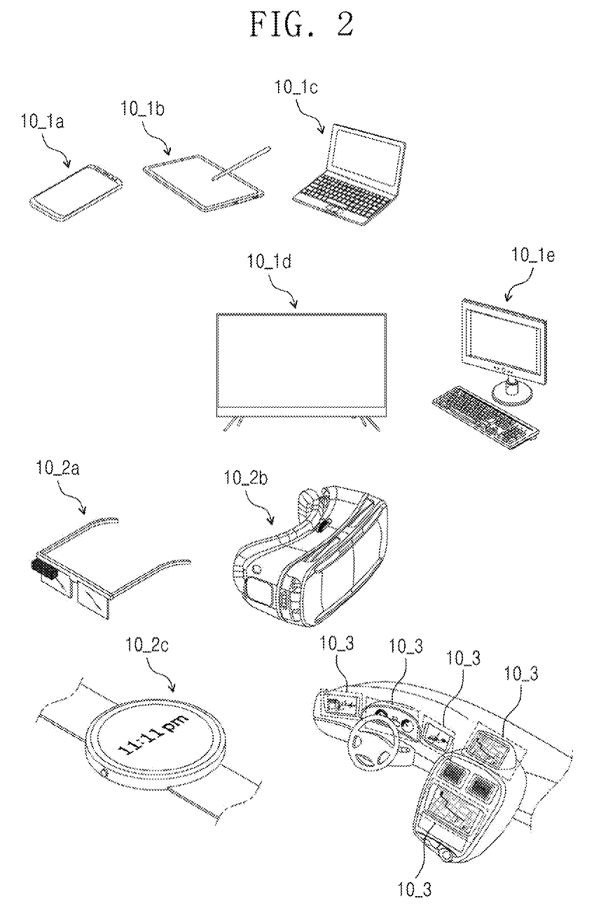

FIG. 2 illustrates a schematic view of electronic devices according to various embodiments.

Referring to FIG. 2, various electronic devices to which a display device according to one or more embodiments is applied may include electronic devices for displaying images, such as a smartphone 10_1a, a tablet PC 10_1b, a laptop 10_1c, a TV 10_1d, and a desk monitor 10_1e, wearable electronic devices each including a display module, such as smart glasses 10_2a, a head mounted display 10_2b, and a smart watch 10_2c, and automotive electronic devices 10_3 each including a display module for a vehicle, such as an instrument panel, a center fascia, a center information display (CID) disposed on a dashboard, and a room mirror display.

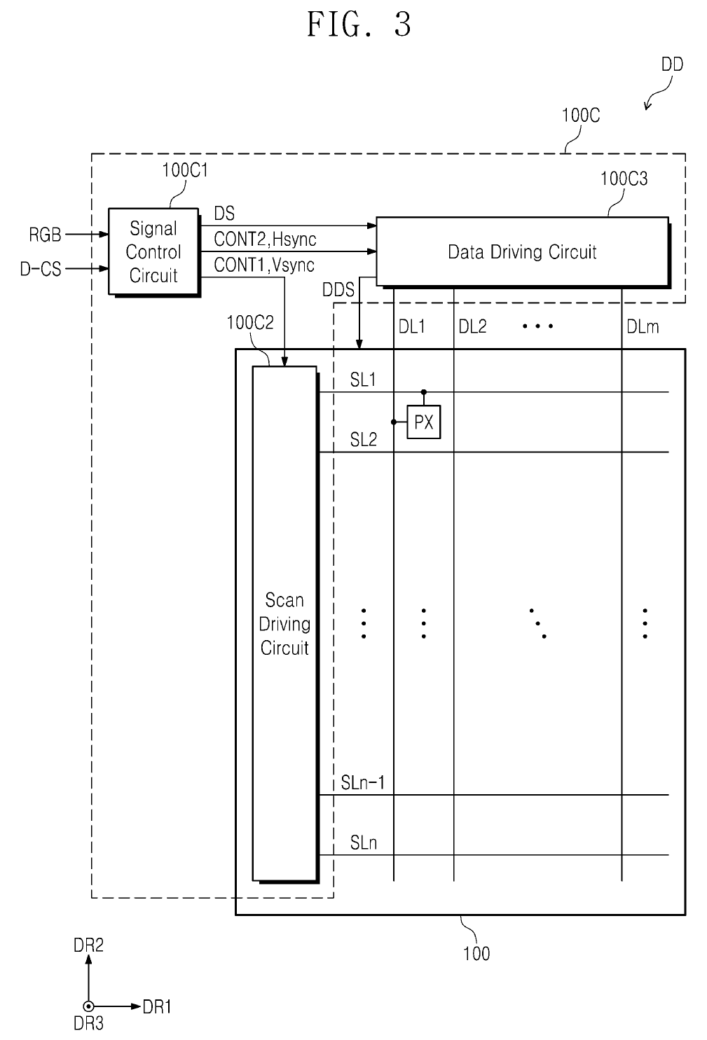

FIG. 3 is a block diagram of a display device DD according to one or more embodiments of the disclosure.

Referring to FIG. 3, the electronic device 1000 (refer to FIG. 1) may include the display device DD. The display device DD may include a display panel 100 and a driver 100C. The display panel 100 and the driver 100C may be components included in the display module 11 (refer to FIG. 1). The driver 100C may be referred to as a driver circuit, a driving part, or a driving unit. The display panel 100 may include a plurality of scan lines SL1, SL2, ..., SLn-1, and SLn, a plurality of data lines DL1, DL2, ..., DLm, and a plurality of pixels PX. Herein, “n” may be an integer of 4 or more, and “m” may be an integer of 3 or more.

Each of the plurality of pixels PX may be connected to a corresponding data line of the plurality of data lines DL1 to DLm and may be connected to a corresponding scan line of the plurality of scan lines SL1 to SLn. In an embodiment of the disclosure, the display panel 100 may further include emission control lines, and the driver 100C may further include an emission driving circuit which provides control signals to the emission control lines. A configuration of the display panel 100 is not particularly limited.

The plurality of scan lines SL1 to SLn may extend in a first direction DR1, and the plurality of scan lines SL1 to SLn may be spaced from each other in a second direction DR2. The plurality of data lines DL1 to DLm may extend in the second direction DR2, and the plurality of data lines DL1 to DLm may be spaced from each other in the first direction DR1.

The driver 100C may receive an image signal RGB and may generate image data DS based on the image signal RGB. For example, the image signal RGB may be received from the processor 12 illustrated in FIG. 1. The driver 100C may include a signal control circuit 100C1, a scan driving circuit 100C2, and a data driving circuit 100C3.

The signal control circuit 100C1 may receive the image signal RGB and a control signal D-CS from the processor 12 (refer to FIG. 1). The control signal D-CS may include various signals. For example, the control signal D-CS may include an input vertical synchronization signal, an input horizontal synchronization signal, a main clock, a data enable signal, etc.

The signal control circuit 100C1 may generate a first control signal CONT1 and a vertical synchronization signal Vsync based on the control signal D-CS and may output the first control signal CONT1 and the vertical synchronization signal Vsync to the scan driving circuit 100C2.

The signal control circuit 100C1 may generate a second control signal CONT2 and a horizontal synchronization signal Hsync based on the control signal D-CS and may output the second control signal CONT2 and the horizontal synchronization signal Hsync to the data driving circuit 100C3.

Also, the signal control circuit 100C1 may output the image data DS, which are obtained by processing the image signal RGB so as to satisfy an operating condition of the display panel 100, to the data driving circuit 100C3. The first control signal CONT1 and the second control signal CONT2 which are signals related to the operations of the scan driving circuit 100C2 and the data driving circuit 100C3 are not particularly limited.

The scan driving circuit 100C2 may drive the plurality of scan lines SL1 to SLn based on the first control signal CONT1 and the vertical synchronization signal Vsync. In an embodiment of the disclosure, the scan driving circuit 100C2 may be formed in the same process as a circuit layer in the display panel 100, but the disclosure is not limited thereto. For example, the scan driving circuit 100C2 may be implemented with an integrated circuit (IC); for electrical connection with the display panel 100, the integrated circuit may be directly mounted on a given area of the display panel 100 or may be mounted on a separate printed circuit board in a chip-on-film; COF) manner.

The data driving circuit 100C3 may output data voltages DDS to the plurality of data lines DL1 to DLm based on the second control signal CONT2, the horizontal synchronization signal Hsync, and the image data DS from the signal control circuit 100C1. The data driving circuit 100C3 may be implemented with an integrated circuit; for electrical connection with the display panel 100, the integrated circuit may be directly mounted on a given area of the display panel 100 or may be mounted on a separate printed circuit board in the chip-on-film manner. However, the disclosure is not particularly limited thereto.

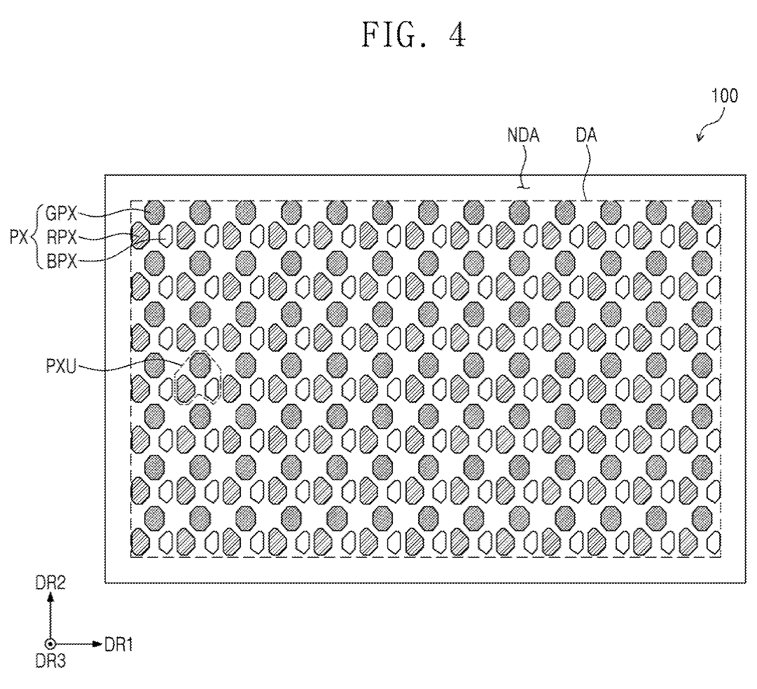

FIG. 4 is a plan view of the display panel 100 according to one or more embodiments of the disclosure.

Referring to FIGS. 3 and 4, the display panel 100 may include a display area DA and a non-display area NDA around the display area DA. The display area DA may display an image, and the non-display area NDA may not display an image. The non-display area NDA may surround the display area DA. However, the disclosure is not limited thereto. For example, a shape of the display area DA and a shape of the non-display area NDA may be changed.

The display area DA may have a shape of a quadrangle defined by two sides (or lines) extending along the first direction DR1 and two sides (or lines) extending along the second direction DR2. This is provided only as an example, and the shape of the display area DA is not limited thereto.

Below, a direction which is substantially perpendicular to a plane defined by the first direction DR1 and the second direction DR2 is defined as a third direction DR3. Also, in the specification, the expression “when viewed from above a plane” may mean “when viewed in the third direction DR3”.

The plurality of pixels PX may be disposed in the display area DA. The pixels PX may include a plurality of first pixels GPX, a plurality of second pixels RPX, and a plurality of third pixels BPX. Sizes of the plurality of first pixels GPX, the plurality of second pixels RPX, and the plurality of third pixels BPX illustrated in FIG. 4 and the placement of the plurality of first pixels GPX, the plurality of second pixels RPX, and the plurality of third pixels BPX are provided only as an example, and the disclosure is not limited thereto.

The plurality of first pixels GPX may emit a green light, the plurality of second pixels RPX may emit a red light, and the plurality of third pixels BPX may emit a blue light. However, the disclosure is not limited thereto. For example, colors of the lights emitted by the plurality of first pixels GPX, the plurality of second pixels RPX, and the plurality of third pixels BPX may be differently changed.

In an embodiment of the disclosure, one first pixel GPX, one second pixel RPX, and one third pixel BPX may emit lights to implement a white image. Accordingly, one first pixel GPX, one second pixel RPX, and one third pixel BPX may be included in one pixel unit PXU.

In an embodiment of the disclosure, when one pixel unit PXU is referred to as a “pixel”, the first pixel GPX, the second pixel RPX, and the third pixel BPX may be respectively referred to as a “first sub-pixel GPX”, a “second sub-pixel RPX”, and a “third sub-pixel BPX”.

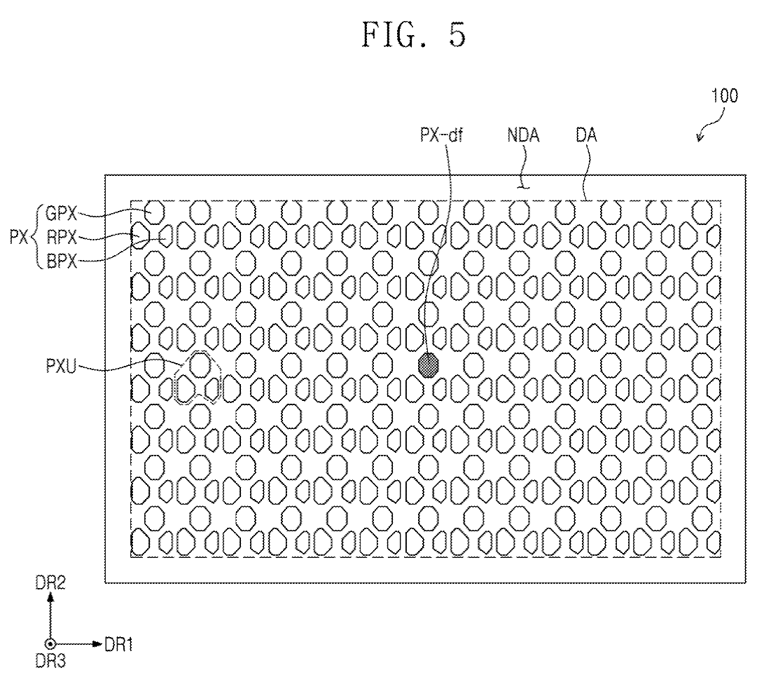

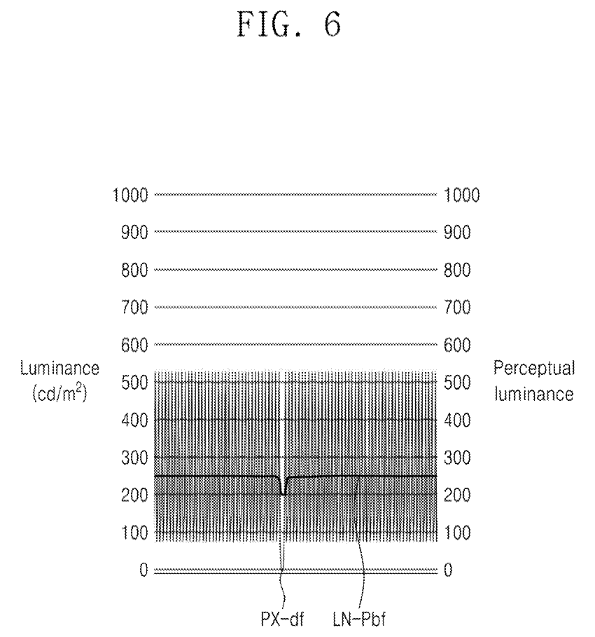

FIG. 5 is a plan view of the display panel 100 according to one or more embodiments of the disclosure. FIG. 6 is a graph illustrating an example of luminance and perceptual luminance of the display panel 100 including a defective pixel PX-df.

Referring to FIGS. 5 and 6, one defective pixel PX-df among the plurality of pixels PX of the display panel 100 is illustrated as an example. When the display panel 100 displays an image, an area where the defective pixel PX-df is disposed may be displayed as a dark spot.

The graph of FIG. 6 may be a graph obtained by measuring luminance of the display panel 100 on which an image of a single grayscale is displayed. The defective pixel PX-df may be a pixel originally designed to emit the green light but fails to emit the green light due to the defect. Accordingly, the luminance (or luminance level) measured in the area where the defective pixel PX-df is disposed may be “0”. In this case, perceptual luminance LN-Pbf perceived by a user may be about 250 cd/m² in a remaining area but may decrease to about 200 cd/m² in an area where the defective pixel PX-df is disposed. In other words, a probability that the user visually perceives the dark spot may increase.

According to an embodiment of the disclosure, the probability that the user visually perceives the dark spot may be decreased through correction of increasing luminance of some of pixels around the defective pixel PX-df and decreasing luminance of some other pixels of the pixels around the defective pixel PX-df. Accordingly, image quality of the display device DD may be improved, and even if the display device DD includes the defective pixel PX-df, the user may not perceive the defective pixel PX-df.

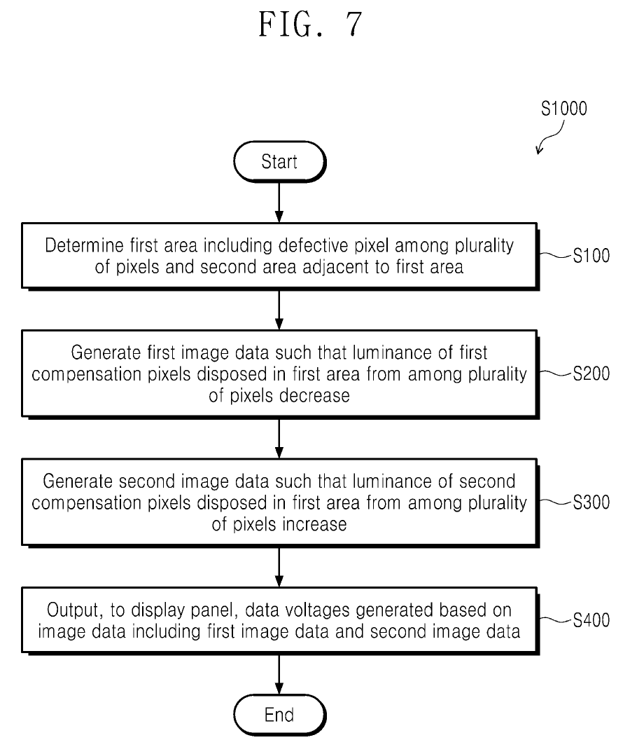

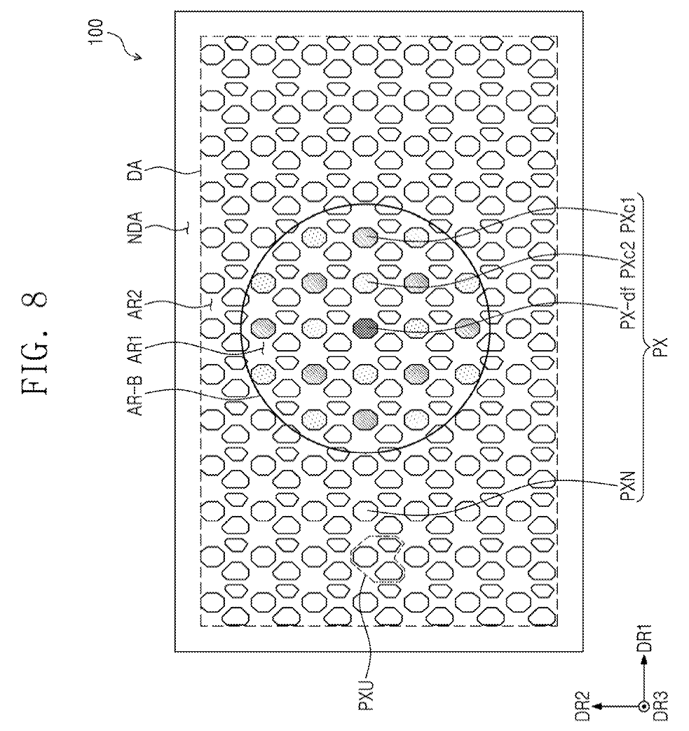

FIG. 7 is a flowchart illustrating an operation of a driver according to one or more embodiments of the disclosure. FIG. 8 is a plan view of a display panel according to one or more embodiments of the disclosure. The various actions, acts, blocks, steps, or the like in the flowchart in FIG. 7 may be performed in the order presented, in a different order or simultaneously. Further, in some embodiments, some of the actions, acts, blocks, steps, or the like may be omitted, added, modified, skipped, or the like without departing from the scope of the disclosure.

Referring to FIGS. 3, 7, and 8, a method of driving the display device DD may include driving the display panel 100 including the plurality of pixels PX (S1000).

The driver 100C may determine a first area AR1 including the defective pixel PX-df among the plurality of pixels PX and a second area AR2 adjacent to the first area AR1 (S100). Location information about the defective pixel PX-df may be stored in the memory 13 (refer to FIG. 1) or may be provided from the processor 12 (refer to FIG. 1).

The display panel 100 may include the first area AR1 including an area where the defective pixel PX-df is disposed, and the second area AR2 adjacent to the first area AR1. The first area AR1 may be an area targeted for correction and may be referred to as a “correction area” or a “compensation area”; the second area AR2 may be an area where correction associated with a defective pixel is not performed and may be referred to as a “non-correction area” or a “non-compensation area”.

A dimension and/or a shape of the first area AR1 may be variously determined. For example, the dimension of the first area AR1 may change depending on a type of the display device DD to which the display panel 100 is applied. Alternatively, the dimension of the first area AR1 may be variously adjusted depending on a size of the display panel 100 and/or a design target. Alternatively, the dimension of the first area AR1 may change depending on a color of the defective pixel PX-df. For example, a visual perception characteristic of the user’s eyes for the green light may be higher than a visual perception characteristic of the user’s eyes for the blue light. Accordingly, the dimension of the first area AR1 corresponding to a case where the defective pixel PX-df is a green pixel may be larger than the dimension of the first area AR1 corresponding to a case where the defective pixel PX-df is a blue pixel.

The shape of the first area AR1 may be variously determined. For example, a boundary AR-B between the first area AR1 and the second area AR2 may be set to have a shape for which sensitivity of the user is relatively low (e.g., may not easily recognized by the user). For example, the shape of the boundary AR-B between the first area AR1 and the second area AR2 may be circular.

The pixels PX may include first compensation pixels PXc1 and second compensation pixels PXc2 disposed in the first area AR1 and a plurality of normal pixels PXN disposed in the second area AR2. In FIG. 8, all pixels other than pixels to which luminance compensation is applied such that the defective pixel PX-df is not visible are not hatched, the first compensation pixels PXc1 are illustrated as having the same hatching, and the second compensation pixels PXc2 are illustrated as having the same hatching.

The driver 100C may generate first image data such that luminance of the first compensation pixels PXc1 decreases (S200) and may generate second image data such that luminance of the second compensation pixels PXc2 increases (S300). For example, when the image signal RGB include the same grayscale information, luminance of the normal pixels PXN may be higher than the luminance of the first compensation pixels PXc1, and the luminance of the normal pixels PXN may be lower than the luminance of the second compensation pixels PXc2.

The driver 100C may output the data voltages DDS, which are generated based on the image data DS including the first image data and the second image data, to the display panel 100 (S400).

In an embodiment of the disclosure, the first compensation pixels PXc1 and the second compensation pixels PXc2 may be arranged alternately and repeatedly in a direction facing away from the defective pixel PX-df. For example, because the defective pixel PX-df is shown as a dark spot when an image is displayed, the second compensation pixel PXc2 corrected such that luminance thereof becomes relatively higher may be disposed the most adjacent to the defective pixel PX-df, and the first compensation pixel PXc1 corrected such that luminance thereof becomes relatively lower may be disposed next thereto.

In an embodiment of the disclosure, all of the defective pixel PX-df, the first compensation pixels PXc1, and the second compensation pixels PXc2 may emit lights of the same color. For example, when the defective pixel PX-df is a pixel configured to emit the green light, some of pixels configured to emit the green light and disposed in the first area AR1 may be the first compensation pixels PXc1, and other pixels configured to emit the green light and disposed in the first area AR1 may be the second compensation pixels PXc2. In an embodiment of the disclosure, luminance correction may not be applied to pixels, which emit a light whose color is different from that of the defective pixel PX-df, from among the pixels disposed in the first area AR1.

According to an embodiment of the disclosure, as the luminance of each of the first compensation pixels PXc1 and the second compensation pixels PXc2 is corrected, a low-frequency spot due to the defective pixel PX-df may be converted into a high-frequency pattern by the defective pixel PX-df, the first compensation pixels PXc1, and the second compensation pixels PXc2 of the first area AR1. A period of the high-frequency pattern may be 60 cycles per degree (CPD) or more. The user (e.g., a person) may fail to perceive a stimulus of 60 CPD or more. Accordingly, as the luminance of the first area AR1 is corrected, the user may fail to perceive the defective pixel PX-df. Accordingly, the image quality of the display device DD (refer to FIG. 3) may be improved.

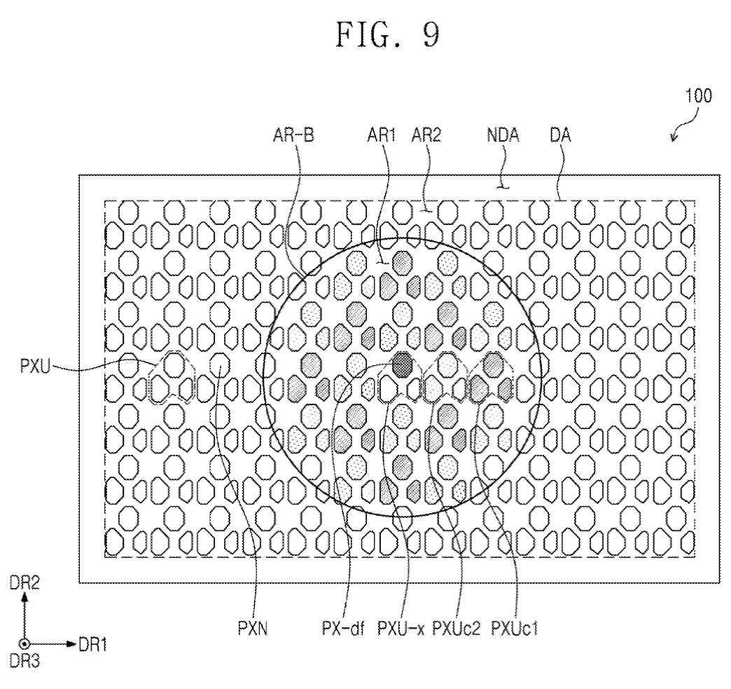

FIG. 9 is a plan view illustrating the display panel 100 according to one or more embodiments of the disclosure.

Referring to FIG. 9, a defective pixel unit PXU-x including the defective pixel PX-df may be defined. The first area AR1 may be an area including the defective pixel unit PXU-x.

In an embodiment of the disclosure, as well as a pixel configured to emit a light of which a color is identical to that of the defective pixel PX-df, all pixels each configured to emit a light of which a color is different from that of the defective pixel PX-df may be corrected. For example, a first compensation pixel unit PXUc1 disposed in the first area AR1 may be corrected such that luminance thereof becomes relatively lower, and a second compensation pixel unit PXUc2 disposed in the first area AR1 may be corrected such that luminance thereof becomes relatively higher.

Also, in an embodiment of the disclosure, in the defective pixel unit PXU-x, remaining pixels other than the defective pixel may not undergo luminance correction, may be corrected such that luminance thereof increases, or may be corrected such that luminance thereof decreases.

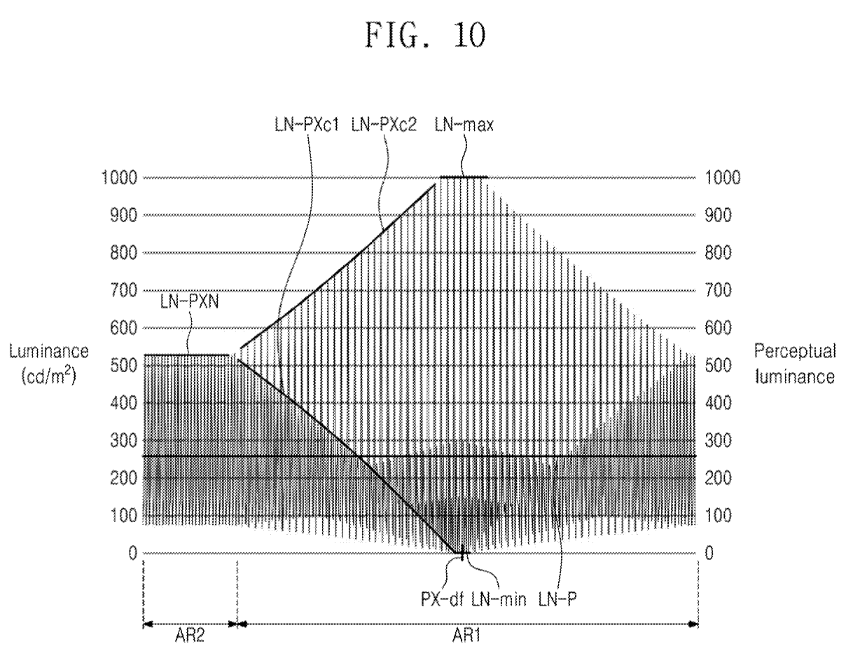

FIG. 10 is a graph illustrating an example of luminance and perceptual luminance according to a location of a pixel of the display panel 100 including a defective pixel according to one or more embodiments of the disclosure.

FIG. 10 shows a graph obtained by measuring luminance of the display panel 100 on which an image of a single grayscale is displayed. The defective pixel PX-df may be a pixel originally designed to emit the green light but fails to emit the green light due to the defect. Accordingly, luminance measured in an area where the defective pixel PX-df is disposed may be “0”.

According to an embodiment of the disclosure, the luminance of the first compensation pixels PXc1 disposed in the first area AR1 may be corrected to be lower than the luminance of the normal pixels PXN, and the luminance of the second compensation pixels PXc2 disposed in the first area AR1 may be corrected to be higher than the luminance of the normal pixels PXN.

As a distance from the defective pixel PX-df increases, luminance LN-PXc1 of the first compensation pixels PXc1 may gradually increase from minimum luminance LN-min. The minimum luminance LN-min may be 0 cd/m². That is, in an embodiment, when the display panel 100 displays an image, at least one of the first compensation pixels PXc1 may be shown as a dark spot.

As a distance from the defective pixel PX-df increases, luminance LN-PXc2 of the second compensation pixels PXc2 may gradually decrease from maximum luminance LN-max. An example in which the maximum luminance LN-max is 1000 cd/m² is illustrated in FIG. 10, but the disclosure is not particularly limited thereto.

As a distance from the defective pixel PX-df increases, the luminance LN-PXc1 of the first compensation pixels PXc1 and the luminance LN-PXc2 of the second compensation pixels PXc2 may converge to luminance LN-PXN of the normal pixels PXN, e.g., near a boundary between the first area AR1 and the second area AR2.

According to an embodiment of the disclosure, the second compensation pixels PXc2 and the first compensation pixels PXc1 may be arranged one by one alternately and repeatedly in a direction facing away from the defective pixel PX-df. In this case, a low-frequency spot due to the defective pixel PX-df may be converted into a high-frequency pattern by the defective pixel PX-df, the first compensation pixels PXc1, and the second compensation pixels PXc2 of the first area AR1. The period of the high-frequency pattern may be 60 cycles per degree (CPD) or more. The user (e.g., a person) may fail to perceive a stimulus of 60 CPD or more. In this case, perceptual luminance LN-P which the user perceives may be uniformly maintained at about 250cd/m² in both the area where the defective pixel PX-df is disposed and the remaining area where the defective pixel PX-df is not disposed. Accordingly, as the luminance of the first area AR1 is corrected, the user may fail to perceive the defective pixel PX-df. Accordingly, the image quality of the display device DD (refer to FIG. 3) may be improved.

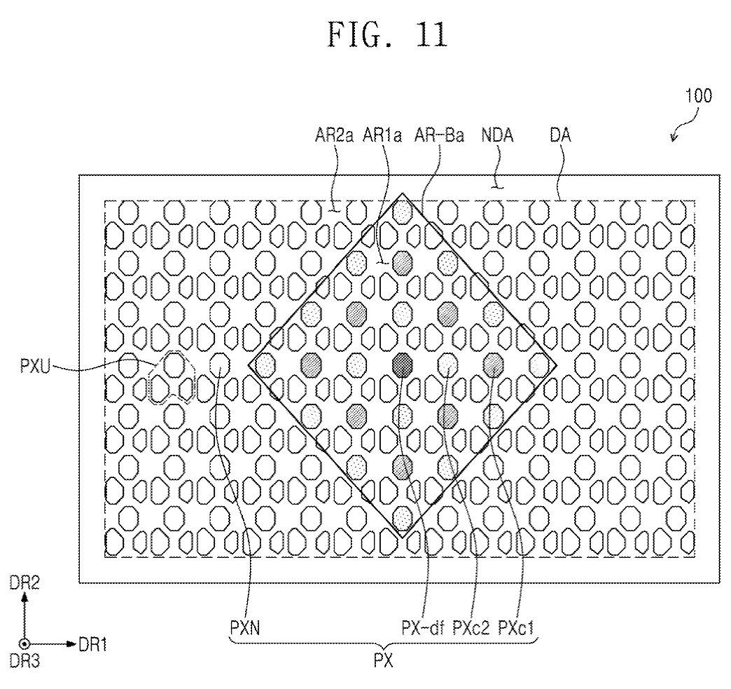

FIG. 11 is a plan view illustrating the display panel 100 according to one or more embodiments of the disclosure.

Referring to FIG. 11, the display panel 100 may include a first area AR1a including an area where the defective pixel PX-df is disposed, and a second area AR2a adjacent to the first area AR1a. The first area AR1a may be an area targeted for correction and may be referred to as a “correction area” or a “compensation area”; the second area AR2a may be an area where correction associated with a defective pixel is not performed and may be referred to as a “non-correction area” or a “non-compensation area”.

A shape of the first area AR1a may be variously determined. For example, a boundary AR-Ba between the first area AR1a and the second area AR2a may be set to have a shape for which sensitivity of the user is relatively low (e.g., may not easily recognized by the user). For example, the boundary AR-Ba between the first area AR1a and the second area AR2a may be in a shape of a rhombus.

According to the above description, even if a defective pixel is present in a display device, luminance of each of first compensation pixels and second compensation pixels disposed in a first area including the defective pixel may be corrected. In this case, a low-frequency spot due to the defective pixel may be converted into a high-frequency pattern by the defective pixel, the first compensation pixels, and the second compensation pixels of the first area. The period of the high-frequency pattern may be 60 CPD or more. The user (e.g., a person) may fail to perceive a stimulus of 60 CPD or more. Accordingly, as the luminance of the first area is corrected, the user may fail to perceive the defective pixel. Accordingly, the image quality of the display device may be improved.

According to an aspect of an example embodiment of the disclosure, provided is a display device comprising: a display panel comprising a plurality of pixels; and a driver configured to generate image data based on an image signal and output the image data to the display panel, wherein the display panel comprises a first area and a second area adjacent to the first area, the first area comprising a defective pixel among the plurality of pixels, wherein the plurality of pixels comprise at least one first compensation pixel in the first area and at least one normal pixel in the second area, and wherein the driver is configured to generate the image data such that a luminance level of the at least one first compensation pixel is lower than a luminance level of the at least one normal pixel.

In an embodiment, the at least one first compensation pixel may comprise a plurality of first compensation pixels, and the driver may be configured to generate the image data such that luminance levels of the plurality of first compensation pixels gradually increase as a distance of a corresponding first compensation pixel from the defective pixel increases.

In an embodiment, at least one of the at least one first compensation pixel and the defective pixel may have a minimum luminance level.

In an embodiment, the plurality of pixels may further comprise at least one second compensation pixel in the first area, and the driver may be configured to generate the image data such that a luminance level of the at least one second compensation pixel is higher than the luminance level of the at least one normal pixel.

In an embodiment, the at least one second compensation pixel may comprise a plurality of second compensation pixels, and the driver may be configured to generate the image data such that luminance levels of the plurality of second compensation pixels gradually decrease as a distance of a corresponding second compensation pixel from the defective pixel increases.

In an embodiment, the at least one first compensation pixel may comprise a plurality of first compensation pixels and the at least one second compensation pixel may comprise a plurality of second compensation pixels, and the plurality of first compensation pixels and the plurality of second compensation pixels may alternate repeatedly.

In an embodiment, based on the image signal having the same grayscale information for the at least one first compensation pixel, the at least one second compensation pixel, and the at least one normal pixel, the luminance level of the at least one normal pixel may be higher than the luminance level of the at least one first compensation pixel, and the luminance level of the at least one normal pixel may be lower than the luminance level of the at least one second compensation pixel.

In an embodiment, the defective pixel, the at least one first compensation pixel, and the at least one second compensation pixel may be configured to emit a light of the same color.

In an embodiment, the at least one first compensation pixel and the at least one second compensation pixel may comprise a pixel configured to emit a light of which a color is identical to a color of the defective pixel and a pixel configured to emit a light of which a color is different from the color of the defective pixel.

In an embodiment, a shape of a boundary between the first area and the second area may be circular or rhombic.

According to an aspect of an example embodiment of the disclosure, provided is a method of driving a display device, the method comprising: driving a display panel comprising a plurality of pixels, the display panel comprising a first area and a second area adjacent to the first area, the first area comprising a defective pixel among the plurality of pixels, wherein the driving the display panel comprises: generating first image data such that a luminance level of at least one first compensation pixel in the first area decreases; generating second image data such that a luminance level of at least one second compensation pixel in the first area increases; and outputting, to the display panel, image data comprising the first image data and the second image data.

In an embodiment, the plurality of pixels may further comprise at least one normal pixel in the second area, and based on an image signal having the same grayscale information for the at least one first compensation pixel, the at least one second compensation pixel, and the at least one normal pixel, a luminance level of the at least one normal pixel may be higher than the luminance level of the at least one first compensation pixel, and the luminance level of the at least one normal pixel may be lower than the luminance level of the at least one second compensation pixel.

In an embodiment, the at least one first compensation pixel may comprise a plurality of first compensation pixels, and luminance levels of the plurality of first compensation pixels may gradually increase as a distance of a corresponding first compensation pixel from the defective pixel increases.

In an embodiment, the at least one second compensation pixel may comprise a plurality of second compensation pixels, and luminance levels of the plurality of second compensation pixels may gradually decrease as a distance of a corresponding second compensation pixel from the defective pixel increases.

In an embodiment, a shape of a boundary between the first area and the second area may be circular or rhombic.

According to an aspect of an example embodiment of the disclosure, provided is an electronic device comprising: a display panel comprising a plurality of pixels, the display panel comprising a first area and a second area adjacent to the first area, the first area comprising a defective pixel among the plurality of pixels; a processor configured to output an image signal; and a driver configured to output image data corresponding to the image signal to the display panel, wherein the plurality of pixels comprise at least one first compensation pixel and at least one second compensation pixel, which are in the first area, and at least one normal pixel in the second area, and wherein, based on the image signal including the same grayscale information for the at least one first compensation pixel, the at least one second compensation pixel, and the at least one normal pixel, a luminance level of the at least one normal pixel is higher than a luminance level of the at least one first compensation pixel, and the luminance level of the at least one normal pixel is lower than luminance level of the at least one second compensation pixel.

In an embodiment, the at least one first compensation pixel may comprise a plurality of first compensation pixels, and the driver may be configured to generate the image data such that luminance levels of the plurality of first compensation pixels gradually increase as a distance of a corresponding first compensation pixel from the defective pixel increases.

In an embodiment, the at least one second compensation pixel may comprise a plurality of second compensation pixels, and the driver may be configured to generate the image data such that luminance levels of the plurality of second compensation pixels gradually decrease as a distance of a corresponding second compensation pixel from the defective pixel increases.

In an embodiment, the at least one first compensation pixel may comprise a plurality of first compensation pixels and the at least one second compensation pixel may comprise a plurality of second compensation pixels, and the plurality of first compensation pixels and the plurality of second compensation pixels may alternate repeatedly.

In an embodiment, a shape of a boundary between the first area and the second area may be circular or rhombic

At least one of the components, elements, modules, units, or the like (collectively "components" in this paragraph) represented by a block or an equivalent indication (collectively “block”) in the above embodiments including the drawings, for example, FIG. 1, may be physically implemented by analog and/or digital circuits including one or more of a logic gate, an integrated circuit, a microprocessor, a microcontroller, a memory circuit, a passive electronic component, an active electronic component, an optical component, and the like, and may be driven by software and/or firmware implemented by computer instruction codes stored in one or more internal or external memories to perform the functions or operations described herein. These components may, for example, be embodied in one or more semiconductor chips, or on substrate supports such as printed circuit boards and the like. These circuits may also be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

While the disclosure has been described with reference to example embodiments thereof, it will be apparent to those of ordinary skill in the art that various changes and modifications may be made thereto without departing from the spirit and scope of the disclosure as set forth in the following claims and their equivalents.

What is claimed is:

1. A display device comprising:
a display panel comprising a plurality of pixels; and
a driver configured to generate image data based on an image signal and output the image data to the display panel,
wherein the display panel comprises a first area and a second area adjacent to the first area, the first area comprising a defective pixel among the plurality of pixels,
wherein the plurality of pixels comprise at least one first compensation pixel in the first area and at least one normal pixel in the second area, and
wherein the driver is configured to generate the image data such that a luminance level of the at least one first compensation pixel is lower than a luminance level of the at least one normal pixel.

2. The display device of claim 1, wherein the at least one first compensation pixel comprises a plurality of first compensation pixels, and
wherein the driver is configured to generate the image data such that luminance levels of the plurality of first compensation pixels gradually increase as a distance of a corresponding first compensation pixel from the defective pixel increases.

3. The display device of claim 1, wherein at least one of the at least one first compensation pixel and the defective pixel has a minimum luminance level.

4. The display device of claim 1, wherein the plurality of pixels further comprise at least one second compensation pixel in the first area, and
wherein the driver is configured to generate the image data such that a luminance level of the at least one second compensation pixel is higher than the luminance level of the at least one normal pixel.

5. The display device of claim 4, wherein the at least one second compensation pixel comprises a plurality of second compensation pixels, and
wherein the driver is configured to generate the image data such that luminance levels of the plurality of second compensation pixels gradually decrease as a distance of a corresponding second compensation pixel from the defective pixel increases.

6. The display device of claim 4, wherein the at least one first compensation pixel comprises a plurality of first compensation pixels and the at least one second compensation pixel comprises a plurality of second compensation pixels, and
wherein the plurality of first compensation pixels and the plurality of second compensation pixels alternate repeatedly.

7. The display device of claim 4, wherein, based on the image signal having the same grayscale information for the at least one first compensation pixel, the at least one second compensation pixel, and the at least one normal pixel, the luminance level of the at least one normal pixel is higher than the luminance level of the at least one first compensation pixel, and the luminance level of the at least one normal pixel is lower than the luminance level of the at least one second compensation pixel.

8. The display device of claim 4, wherein the defective pixel, the at least one first compensation pixel, and the at least one second compensation pixel are configured to emit a light of the same color.

9. The display device of claim 4, wherein the at least one first compensation pixel and the at least one second compensation pixel comprise a pixel configured to emit a light of which a color is identical to a color of the defective pixel and a pixel configured to emit a light of which a color is different from the color of the defective pixel.

10. The display device of claim 1, wherein a shape of a boundary between the first area and the second area is circular or rhombic.

11. A method of driving a display device, the method comprising:
driving a display panel comprising a plurality of pixels, the display panel comprising a first area and a second area adjacent to the first area, the first area comprising a defective pixel among the plurality of pixels,
wherein the driving the display panel comprises:
generating first image data such that a luminance level of at least one first compensation pixel in the first area decreases;
generating second image data such that a luminance level of at least one second compensation pixel in the first area increases; and
outputting, to the display panel, image data comprising the first image data and the second image data.

12. The method of claim 11, wherein the plurality of pixels further comprise at least one normal pixel in the second area, and
wherein, based on an image signal having the same grayscale information for the at least one first compensation pixel, the at least one second compensation pixel, and the at least one normal pixel, a luminance level of the at least one normal pixel is higher than the luminance level of the at least one first compensation pixel, and the luminance level of the at least one normal pixel is lower than the luminance level of the at least one second compensation pixel.

13. The method of claim 11, wherein the at least one first compensation pixel comprises a plurality of first compensation pixels, and
wherein luminance levels of the plurality of first compensation pixels gradually increase as a distance of a corresponding first compensation pixel from the defective pixel increases.

14. The method of claim 11, wherein the at least one second compensation pixel comprises a plurality of second compensation pixels, and
wherein luminance levels of the plurality of second compensation pixels gradually decrease as a distance of a corresponding second compensation pixel from the defective pixel increases.

15. The method of claim 11, wherein a shape of a boundary between the first area and the second area is circular or rhombic.

16. An electronic device comprising:
a display panel comprising a plurality of pixels, the display panel comprising a first area and a second area adjacent to the first area, the first area comprising a defective pixel among the plurality of pixels;
a processor configured to output an image signal; and
a driver configured to output image data corresponding to the image signal to the display panel,
wherein the plurality of pixels comprise at least one first compensation pixel and at least one second compensation pixel, which are in the first area, and at least one normal pixel in the second area, and
wherein, based on the image signal including the same grayscale information for the at least one first compensation pixel, the at least one second compensation pixel, and the at least one normal pixel, a luminance level of the at least one normal pixel is higher than a luminance level of the at least one first compensation pixel, and the luminance level of the at least one normal pixel is lower than luminance level of the at least one second compensation pixel.

17. The electronic device of claim 16, wherein the at least one first compensation pixel comprises a plurality of first compensation pixels, and
wherein the driver is configured to generate the image data such that luminance levels of the plurality of first compensation pixels gradually increase as a distance of a corresponding first compensation pixel from the defective pixel increases.

18. The electronic device of claim 16, wherein the at least one second compensation pixel comprises a plurality of second compensation pixels, and
wherein the driver is configured to generate the image data such that luminance levels of the plurality of second compensation pixels gradually decrease as a distance of a corresponding second compensation pixel from the defective pixel increases.

19. The electronic device of claim 16, wherein the at least one first compensation pixel comprises a plurality of first compensation pixels and the at least one second compensation pixel comprises a plurality of second compensation pixels, and
wherein the plurality of first compensation pixels and the plurality of second compensation pixels alternate repeatedly.

20. The electronic device of claim 16, wherein a shape of a boundary between the first area and the second area is circular or rhombic.
